(19) United States
(12) Patent Application Publication
(10) Pub. No.: US 2014/0329124 A1
(43) Pub. Date: Nov. 6, 2014

(54) Battery pack design for integrating and monitoring multiple single battery cells

(71) Applicant: Arcimoto, LLC, Eugene, OR (US)

(72) Inventors: Mark Douglas Frohnmayer, Eugene, OR (US); James Kevin Jordan, Junction City, OR (US); Terry Leon Becker, Creswell, OR (US)

(73) Assignee: ARCIMOTO, LLC, Eugene, OR (US)

(21) Appl. No.: 14/268,236

(22) Filed: May 2, 2014

Related U.S. Application Data
(60) Provisional application No. 61/818,682, filed on May 2, 2013.
(60) Provisional application No. 61/877,196, filed on Sep. 12, 2013.

(51) Int. Cl. H01M 2/10

(52) U.S. Cl. CPC H01M 2/1016; H01M 2/1022; H01M 2/1072
USPC 429/99; 429/100

(57) ABSTRACT

The present invention is directed toward apparatuses for packaging one or more cells in a larger battery pack, and apparatuses for electrically coupling a battery management system to the one or more cells in a battery pack. In the aspect of the present invention directed toward battery packaging apparatus with integrated spring contacts, said embodiment is comprised of an electrically conductive element that has a first and second surface, with the first surface electrically coupled to a first battery, and a first spring like element that is coupled to the first face of the electrically conductive element. The electrically conductive element has a cross section such that the second surface contacts the spring like element in two areas; a first and second area. The spring like element is operable for providing a force on the electrically conductive element when the first area is translocated toward the second area.

### CROSS-REFERENCE TO RELATED APPLICATIONS

This application claims the benefit of U.S. Provisional Application No. 61/818,682 filed May 2, 2013 titled “Battery cell with integrated spring contacts.”

This application claims the benefit of U.S. Provisional Application No. 61/877,196 filed Sep. 12, 2013 titled “Battery pack for integrating multiple single battery cells and a battery management system.”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the field of electronics and pertains particularly to methods and apparatuses for integrating multiple battery cells and a battery management system to form a battery pack.

2. Summary of the prior art

In the field of electronics, newer lithium-based batteries have been developed that have much higher energy density ratings than previous generation technologies such as Nickel Cadmium or Nickel Metal Hydride. These lithium batteries require management to preserve battery longevity and safety. Characteristics managed include over current, over voltage and under voltage conditions. A battery pack may comprise one or more battery cells of a given battery chemistry.

For example, an 18650-sized lithium ion battery cell may have a 3.6 volt potential and 2.0 amp hour capacity. In order to build a pack of higher voltage and higher capacity, multiple groups of parallel-connected battery cells may be connected in series. A 50.4 volt battery pack with 10 amp hour capacity could be constructed by connecting in series 14 parallel-connected groups of 5 of the afore mentioned battery cells.

A conventional means for integrating multiple battery cells by direct coupling of the battery terminals of multiple battery cells to each other via a spot-welded conductor of nickel metal creates safety issues during pack assembly and maintenance, and long term wear issues from wires connecting from the intermediate conductor to a battery management system. This traditional method may also require a larger investment in production equipment. In the prior art, Kalman (US Pat. App. 2012/0148877 A1) describes using parallel printed circuit boards (PCB) to conduct current between multiple battery cells positioned by two positioning plates and forming a contact via a loosely-coupled intermediate conductive component. In a high power application, inconsistent impedance in the intermediate conductive component can cause battery cells to age at different rates, and because printed circuit boards have poor thermal transfer through the outer, current-insulating layer, battery cells may overheat.

Further, embedding the battery management components into the same circuit boards that carry pack current between groups of cells may introduce additional complexity, layering and cost in the PCB manufacturing process, and packs that are too large to fit within the bounds of a single printed circuit board may require costly interconnects between sub modules.

Additionally, while the nominal dimensions of an individual cell may be the same, in practice the dimensions of individual cells in a battery may vary. A particular problem in larger collections of cells is ensuring the even flow of current and heat from the terminals of the battery. Differing actual dimensions further exacerbates this problem.

In practice, terminals may be soldered or welded to a shared conductive medium, however such connections may require expensive tooling for production, or they may fatigue in a high vibration environment. Terminals may also be electrically connected to a shared conductive medium via an intermediate conductive component such as a spring that provides sufficient force to preserve electrical connection. Springs may not, however, have the thermal and/or electrical conductivity sufficient for a particular application or may be expensive to manufacture or assemble. US Pat. App. 2012/0148877 A1 discloses a battery pack made up of cells held in tension between two conductive media via an intermediate conductive component which is a spring made from a conductive material or a compressible clip, or shim, made of spring steel. In both cases, such springs may have dissimilar impedance, require the medium that conducts current to also provide spring force, and add extra parts and manufacturing cost to a battery pack assembly.

Therefore, what is clearly needed is a complete solution that offers the ability to monitor cell charge states with a battery management system while accommodating the variation in the actual size of cells.

### SUMMARY OF THE INVENTION

One aspect of the present invention is a battery packaging apparatus with integrated spring contacts comprised of an electrically conductive element that has a first and second surface, with the first surface electrically coupled to a first battery, and a first spring like element that is coupled to the first face of the electrically conductive element. The electrically conductive element has a cross section such that the second surface contacts the spring like element in two areas; a first and second area. The spring like element is operable for providing a force on the electrically conductive element when the first area is translocated toward the second area.

Another aspect of the invention is an attachment apparatus for a battery management system comprising a planar conduction medium that is electrically coupled to at least one battery, a first electrically conductive trace with a first and second leg wherein the first leg is substantially perpendicular to the second leg, and the first leg is electrically coupled to the first planar conduction medium, and a connector for coupling the second leg of the first electrical trace to a battery management system.

Still another aspect of the invention is an attachment apparatus for a battery management system comprising a planar conduction medium that is electrically coupled to at least one battery, a first electrically conductive trace that extends from the first planar conduction medium wherein the electrically conductive trace is electrically coupled to the first planar conduction medium and the electric coupling between the first planar conduction medium and the electrically conductive trace is maintained by friction between the first planar conduction medium and a substantially parallel nonconductive surface, and a connector for coupling the first electrical trace to a battery management system.

### BRIEF DESCRIPTION OF THE DRAWINGS

FIG. 1 depicts a battery pack constructed according to aspects of the invention.

FIG. 2 depicts the battery pack shown in FIG. 1 with features removed to facilitate understanding.

FIG. 3 depicts a flexible PCB constructed according to aspects of the invention.

FIG. 4 is a detail view of the flexible PCB constructed according to aspects of the invention as shown in FIG. 3.

FIG. 5 is a cross section view of the embodiment shown in FIG. 1.

FIG. 6 is a detail view of the cross section view of the embodiment shown in FIG. 5.

FIG. 7 is a detail view of the cross section view of the embodiment shown in FIG. 6.

FIG. 8 depicts battery packaging apparatus constructed according to aspects of the invention.

FIG. 9 depicts a cut away view of an electrically conductive member constructed according to aspects of the invention.

FIG. 10 depicts a partially assembled battery pack constructed according to aspects of the invention.

FIG. 11 depicts a partially assembled battery pack constructed according to aspects of the invention.

FIG. 12 depicts a battery packaging apparatus constructed according to aspects of the invention.

FIG. 13 depicts a cross section view of a battery pack constructed according to aspects of the invention.

FIG. 14 depicts a detail view of the cross section view of a battery pack constructed according to aspects of the invention shown in FIG. 13.

### DETAILED DESCRIPTION OF THE INVENTION

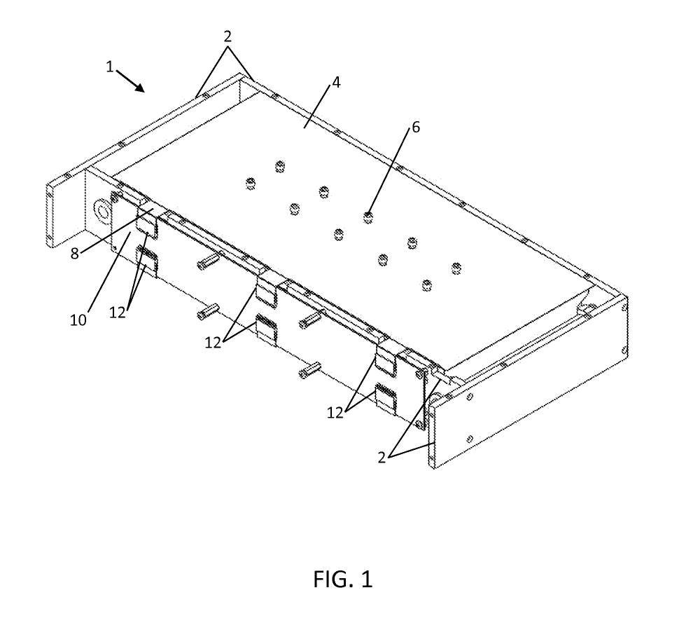

Referring to FIG. 1, FIG. 1 shows a battery pack 1 constructed according to one embodiment of the present invention. The battery pack 1 is comprised of a housing 2, a non-conductive board element 4, a plurality of compression fasteners 6, a battery management system 10, and a plurality of connectors 12 which connect a flexible PCB 8 with traces 9 to the battery management system 10.

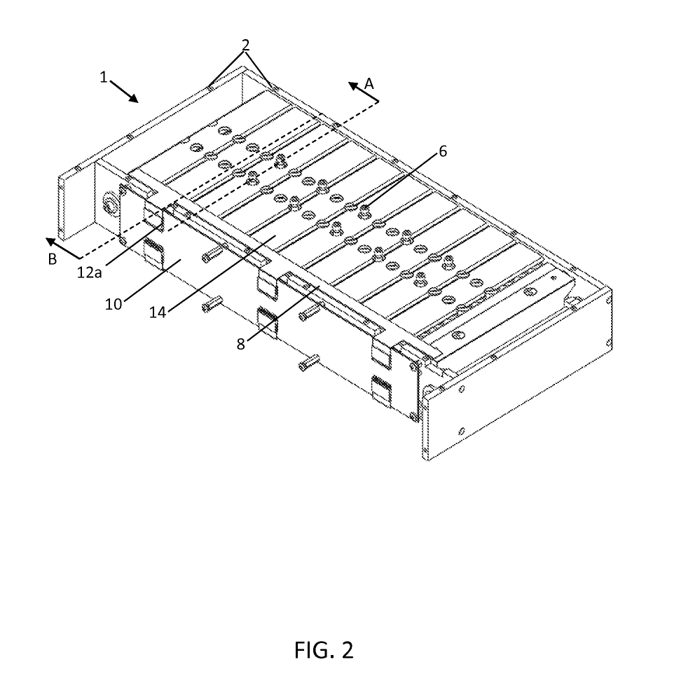

FIG. 2 depicts the embodiment of a battery pack 1 as shown in FIG. 1 without a non-conductive board element 4. In FIG. 2, with the removal of the non-conductive board element 4 the plurality of electrically conductive elements 14 are now visible. Additionally, it is possible to see the flexible PCB 8 with traces 9 (not shown in FIG. 2) which rests on top of the electrically conductive elements 14 and below the non-conductive board element 4. Further, FIG. 1 shows two section lines, A and B which run through the center line of two compression fasteners 6 and the edge of a connector 12a, respectively.

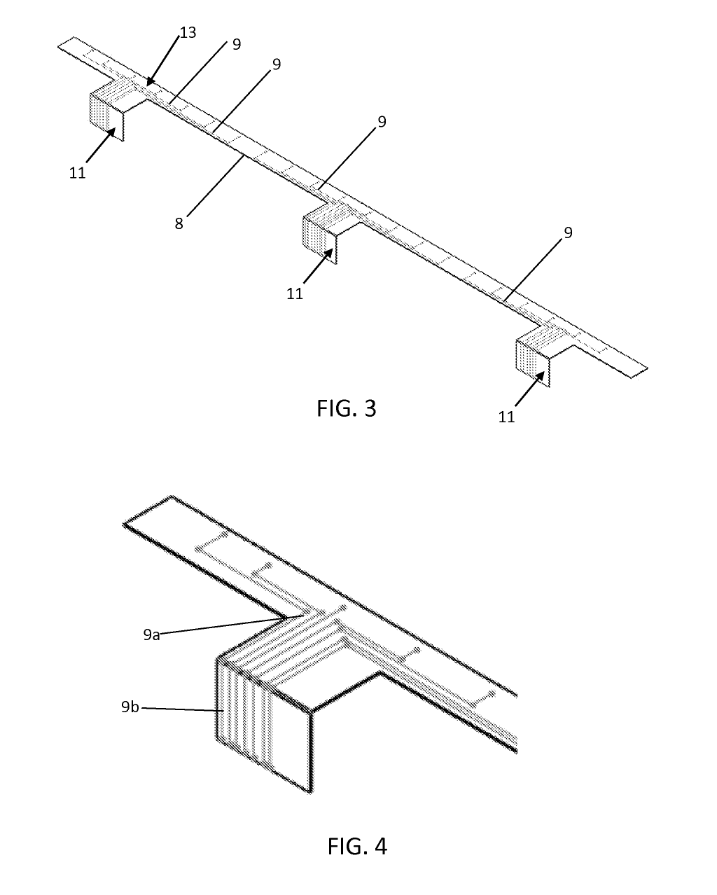

Referring to FIG. 3 in more detail, FIG. 3 depicts an embodiment of the traces 9 as taught by the invention. In the embodiment shown in FIG. 3, a plurality of traces 9 are located on a flexible PCB 8. The flexible PCB 8 has a first face 13 and a second face 11. The first face 13 and second face 11 are substantially perpendicular in the preferred embodiment. However, in other embodiments the first face 13 and second face 11 may be oriented at any angle relative to one another including being co-planar.

The plurality of traces 9 are operable for conducting electricity from one end to another. Thus any electrically conductive material is suitable for use as a trace, including copper, brass, and steel. Although the embodiment shown in FIG. 3 has each trace 9 as a trace on a single PCB board 8, each trace could alternatively be a wire or a strip of conductive material. Further, each individual trace 9 need not be mounted on the same surface as the other traces 9 as shown in FIG. 3.

FIG. 4. depicts the embodiment of the traces 9 as shown in FIG. 3 in more detail. In FIG. 4, the first leg 9a and second leg 9b of an individual trace 9 are shown. The first leg 9a includes the entirety of the trace 9 located on the first face 13 of the PCB 8, and the second leg 9b includes the entirety of the trace 9 located on the second face 11 of the PCB 8. In the embodiment shown in FIG. 4 the first leg 9a and the second leg 9b form two planes that are substantially perpendicular. However, in alternative embodiments, the first leg 9a and second leg 9b of a trace 9 may be oriented at any angle relative to one another, including co-planer.

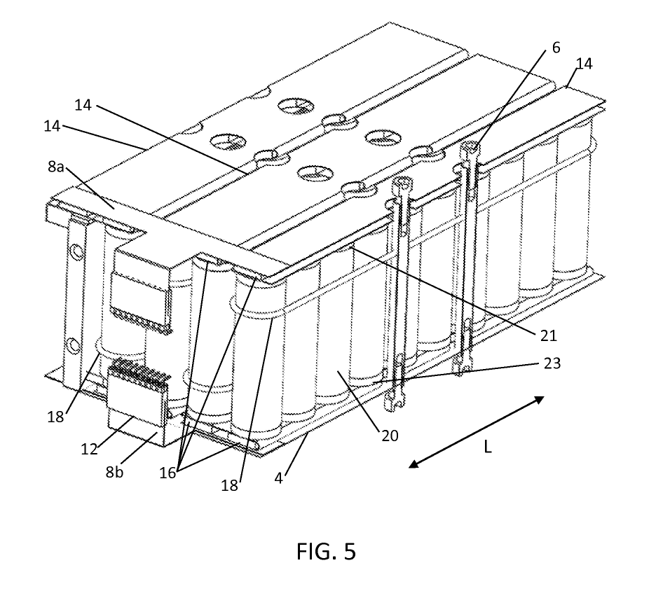

FIG. 5 depicts a section view of the battery pack 1 shown in FIG. 2 taken at section A. The housing 2 and battery management system 10 are not shown, for clarity. In FIG. 5 the plurality of cells 20 are visible. The cells 20 are standard cylindrical lithium ion cells. However, in alternative embodiments, the cells may be a prismatic or pouch type lithium ion cell. Alternatively, the cells may be of any other chemistry as a particular application would require.

The cells 20 are located in rows oriented in direction L. The cells in a particular row are bound by bands 18 that are located circumferentially around the one or more cells 20 in a particular row. In embodiments with a single cell in each row, the band 18 is tight fit around the circumference of that particular cell, whereas in embodiments where there are a plurality of cells 20 located in a row, the band 18 is located circumferentially around all of the cells 20 in that row, as shown in FIG. 5. The band 18 serves to provide a discrete spacing distance between adjacent rows of cells. One benefit of discrete spacing between adjacent rows of cells is that a thermal runaway event in one cell will not cause a cascading chain reaction in adjacent cells. The band may be an o-ring or a strap or other configuration which is capable of creating a discrete spacing between adjacent rows of cells. The band may be made out of plastic, rubber, silicone, or any other material suitable for providing a discrete spacing between adjacent rows of cells.

Each cell 20 has a second terminal 21 and a first terminal 23. The first terminal 23 and second terminal 21 are electrically coupled to different electrically conductive elements 14. In the embodiment shown in FIG. 5, the first terminal 23 is electrically coupled to an electrically conductive element 14 by spot welding. The second terminal 21 is electrically coupled to an electrically conductive element 14 via a metal strip 22 (not visible in FIG. 5) which is spot welded to the second terminal 23 and which then rests upon the electrically conductive element 14. In each row, the orientation of the cells is opposite the previous row such that the terminals in the same plane of the battery pack 1 alternate positive, negative, positive, and onward in this pattern in the long direction of the flexible PCB 8. In a particular row extending perpendicular to the flexible PCB 8, the terminals share a polarity.

There are two flexible PCB's 8a, 8b (traces 9 not shown for clarity) depicted in FIG. 5. The top PCB 8a and traces 9 (not shown for clarity) are electrically coupled to the plurality of electrically conductive members 14 by being in contact with the electrically conductive members 14. The bottom PCB 8b and traces 9 (not shown for clarity) are located between a plurality of electrically conductive members 14 and a non-conductive board element 4. The electric coupling between the bottom PCB 8a and the plurality of electrically conductive elements 14 is enhanced by a pressure applied on the bottom PCB 8b and the traces 9 (not shown for clarity). The pressure is applied by tightening the compression fasteners 6 and forcing the non-conductive board element 4 against the plurality of electrically conductive members 14. This pressure serves to secure the PCB 8b and traces 9 (not shown for clarity) in the location where they are electrically coupled to the plurality of electrically conductive members 14. In various other embodiments, there may be additional layers between the non-conductive board element 4 and the electrically conductive members 14. For example a thermal interface material may be located between the non-conductive board element 4 and the electrically conductive members 14 in order to maximize the heat transfer though the electrically conductive element 14 and into the electrically non-conductive board element 14.

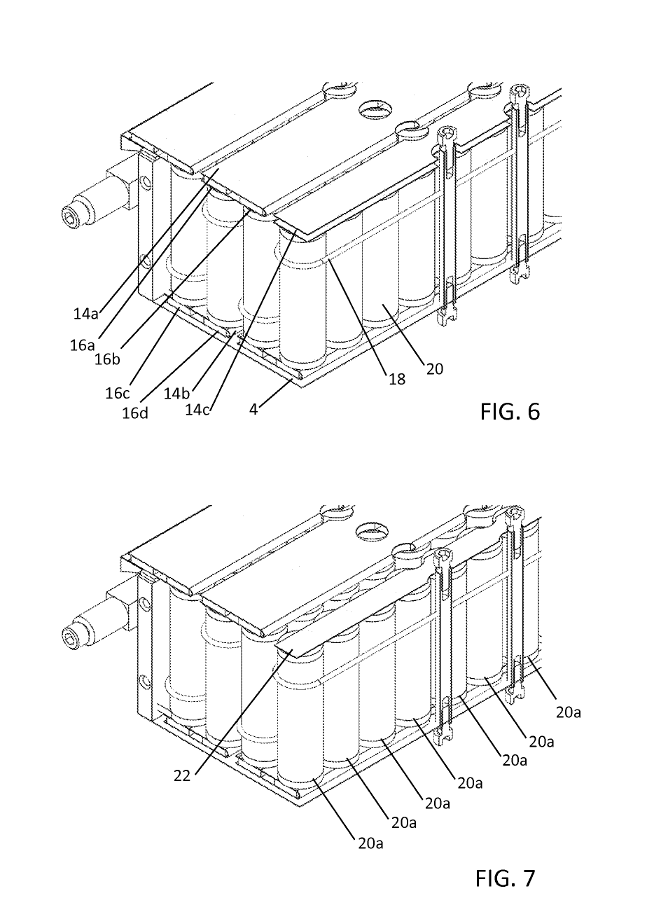

In FIG. 6, the embodiment shown in FIG. 5 is shown with the connectors 12 and PCB's 8 removed. The plurality of spring elements 16a,16b,16c,16d are visible. Top electrically conductive members 14a,14c and a bottom electrically conductive member 14b are shown.

FIG. 7 depicts the embodiment shown in FIG. 6 with one of the top electrically conductive members 14c removed. A conductive strip 22 is now visible. The conductive strip 22 may be made out of any electrically conductive material and operates to ensure that all the cells in a row 20a are at the same potential. The conductive strip 22 is preferably spot welded to the cells in a row 20a, however, the strip may be attached in any way including adhesives, or stamped recesses in the conductive strip 22 that are sized to fit the cell 20a terminals. Using a conductive strip 22 creates a larger contact area, than just cell terminals, between the attached cell terminals and the electrically conductive member 14. As a result of a larger contact area less pressure is needed to create consistent impedance between rows of cells electrically connected via the electrically conductive member. Also, a larger contact area reduces the pressure that is exerted on the safety blowout valve located at the top of each cell.

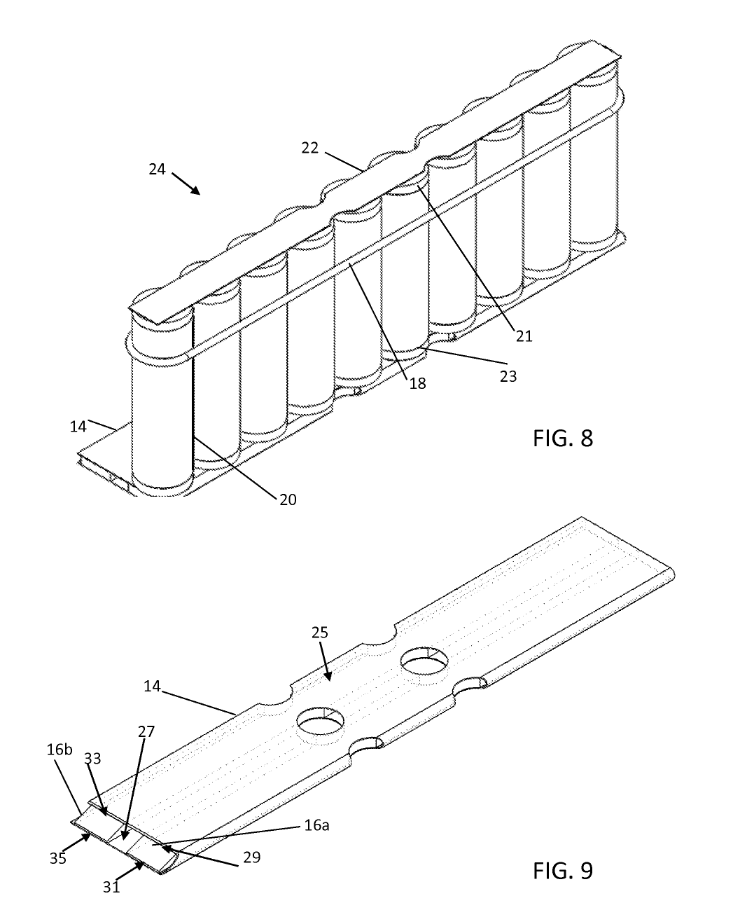

FIG. 8 depicts a preferred embodiment of a battery packaging apparatus 24 constructed according to aspects of the invention. A conductive strip 22 is electrically coupled to a plurality of cells 20 at the plurality of second terminals 21. An electrically conductive member 14 is electrically coupled to the plurality of cells 20s at a first terminals 23. Preferably, the plurality of cells 20 are spot welded to the electrically conductive member 14 at the plurality of first terminals 23. However, the electrically conductive member 14 may be attached in any way including adhesives, or stamped recesses in the electrically conductive member that are sized to fit the plurality of first terminals 23. Although the embodiment depicted in FIG. 8 uses a plurality of cells 20, different embodiments employ only one cell 20 in each row. Still further embodiments envision any number of cells 20 in the row as long as the plurality of cells maintain the connection schema described herein.

FIG. 9 depicts a cut away view of an electrically conductive member 14. The cut-away reveals a first spring element 16a and a second spring element 16b. The first spring element is coupled to the electrically conductive member 14 at a first area 29 and a second area 31. The second spring element 16a is coupled to the electrically conductive member at a third area 33 and a fourth area 35.

Referring to the electrically conductive member 14 in more detail, the electrically conductive member 14 has a first surface 25 and a second surface 27. In the preferred embodiment the electrically conductive member 14 is constructed from copper. However, any electrically conductive material will be suitable. In the embodiment depicted in FIG. 9 the electrically conductive member 14 has ‘U’ shaped cross section. This shape enables efficient manufacturing by mechanical processes, however other embodiments have different cross sectional shapes. The limiting factor is that in embodiments with only one spring like element the first area 29 is located approximately across from the second area 31. The limiting factor in embodiments with two spring like elements is that the first area 29 is located approximately across from the second area 31 and that the third area 33 is approximately across from the fourth area 35. As long as these conditions are met a wide variety of cross sectional shapes are suitable.

Referring to the first spring like element 16a in more detail, the first spring like element 16a must be capable of providing a resistive force against the second face 27 when the first area 29 is translocated toward the second area 31 or vise-versa. In operation, this resistive force serves to maintain contact between the first surface 25 and the non-conductive board element 4. The first spring element 16a is coupled to the second surface 27 via adhesives, or mechanical fasteners. The first spring element 16a may be coupled at the first area 29 and the second area 31 or both.

Referring to the second spring element 16b in more detail, the second spring like element 16b must be capable of providing a resistive force against the second face 27 when the third area 33 is translocated toward the fourth area 35, or vise-versa. In operation, this resistive force serves to maintain contact between the first surface 25 and the non-conductive board element 4. The second spring like element 16b is coupled to the second surface 27 via adhesives, or mechanical fasteners. The second spring like element 16b may be coupled at the second area 31 and the third area 35 or both.

Referring to spring like elements 16 in more detail, the spring like elements 16 may be constructed out of a wide range of materials. Depending on the mechanical and cost requirements of the battery application, different materials may be employed. For example, in one embodiment of the invention, the spring like element is made of spring steel for proven long term mechanical wear advantage. In another embodiment of the invention, the spring like element is made of beryllium copper for optimized heat transfer through the spring. In yet another embodiment of the invention, the spring like element is made of polyurethane globules deposited on the second surface. Other suitable materials include synthetic resins and adhesive-backed foam. Still further embodiments have more complex spring like elements, where the spring like elements is constructed from a self-resetting bi-metallic component. Additionally, in further embodiments, the first spring like element 16a and second spring like element 12b may be different areas of a single spring like element.

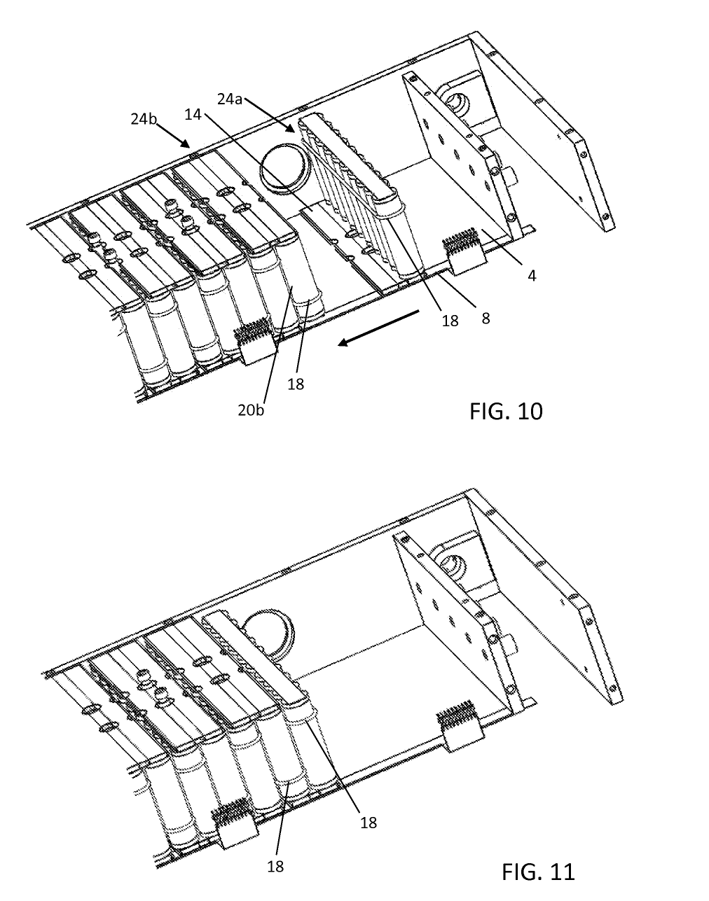

The embodiment depicted in FIG. 8 simplifies the assembly of a large array of cells in series, such as in a battery pack 1. FIG. 10 and FIG. 11 show two stages of assembling a battery pack 1 with the embodiment depicted in FIG. 8. The battery packaging apparatus 24 holds the one or more cells 20 in place relative to one another and the electrically conductive member 14 and conductive strip 22 are coupled to the cells 20 as described above. FIG. 10 shows a previously installed battery packaging apparatus 24b and new battery packaging apparatus 24a. The new battery packaging apparatus 24a is placed in the housing 2 such that it rests on the non-conductive board element 4 and the flexible PCB 8. The new battery packaging apparatus 24a is moved in direction L until the electrically conductive member 14 from the new battery packaging apparatus 24a compress under the conductive strip 22 (not visible in FIG. 10) attached to cells in the previously installed battery packaging apparatus 24b. The bands 18 on the battery packaging apparatuses 24a, 24b ensure the correct spacing.

The new battery packaging apparatus 24a and the previously installed battery packaging apparatus 24b are both constructed in accordance with the embodiment in shown in FIG. 8. However, the new battery packaging apparatus 24a and the previously installed battery packaging apparatus 24b are oriented so that the respective electrically conductive members are located opposite one another. This alternating orientation is repeated until the final voltage for the battery pack 1 is reached.

Notably, in the embodiment of the invention shown in FIG. 1, and as shown during assembly in FIG. 10 and FIG. 11, requires no wires to assembly. The plurality of cells used to power the battery pack 1 are fixed in a plurality of battery packaging apparatuses 24. During assembly the electrical coupling between a new battery packaging apparatus 24a and the previously installed battery packaging apparatus 24b is achieved by the electric coupling of the elongated member on the new battery packaging apparatus 24a and a conductive strip on the preciously installed battery packaging apparatus 24a. The second spring element 16b provides a force on the second surface 27 as the electrically conductive member 14 is compressed during assembly. This force ensures an electric coupling between the electrically conductive member 14 on the new battery packaging apparatus 24a and the strip 22 on the previously installed battery packaging apparatus 24b.

Further, the battery management system 10 is electrically connected to the plurality of cells via traces 9 on a flexible PCB 8 that rests between the non-conductive board element 4 and the one or more electrically conducive member 14. The electric coupling between the traces 9 and the electrically conducive member 14 is achieved by the pressure applied between the electrically conductive member 14 and non-conducive board element.

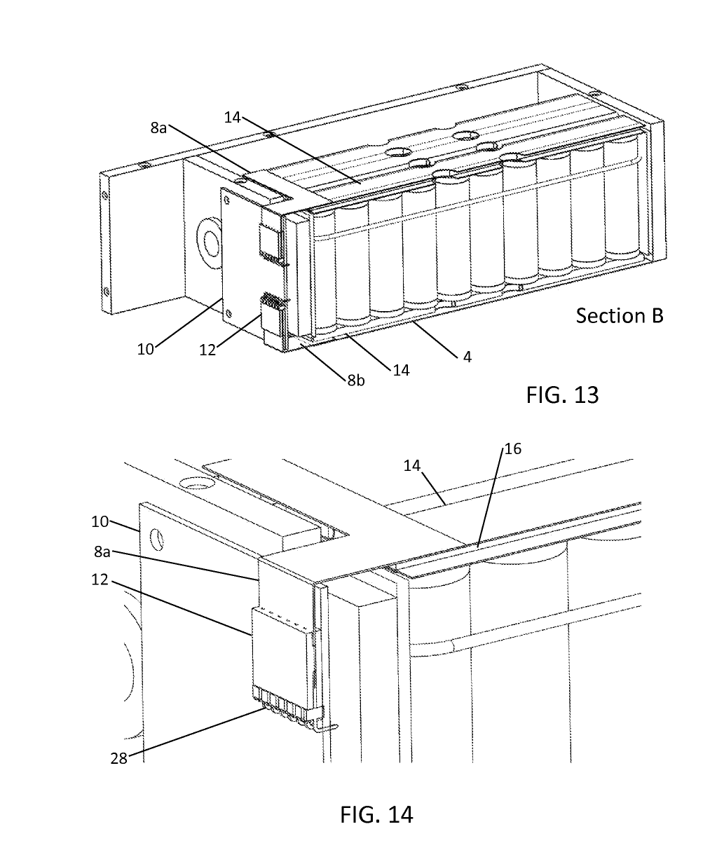

FIG. 13 is a section view at Section B of the embodiment of the invention shown in FIG. 2. Readily apparent in FIG. 13 is a top flexible PCB 8a and a bottom flexible PCB 8b. In the embodiment shown in FIG. 13, the use of a top flexible PCB 8a and a bottom flexible PCB 8b and associated traces 9, enables the battery management system 10 to monitor the voltage across each row of cells in parallel. Additionally, FIG. 13 shows the non-conductive board member 4 and an electrically conductive member 14 compressed against the bottom flexible battery management system 8b. Although a top non-conductive board element is not shown (for clarity), in operation, a top non-conductive board element is used to compress the top flexible PCB 8a against a plurality of electrically conductive members 14.

Referring to FIG. 14, FIG. 14 shows a detail view of the top flexible PCB 8a. The connector 12 in this embodiment uses a plurality of pins 28 which electrically couple the traces 9 (not shown in FIG. 14) on the top flexible PCB 8a to the battery management system 10. In further embodiments, the connector may be a plastic snap type connector or the bare ends of the traces 9 which would be suitable for soldering.

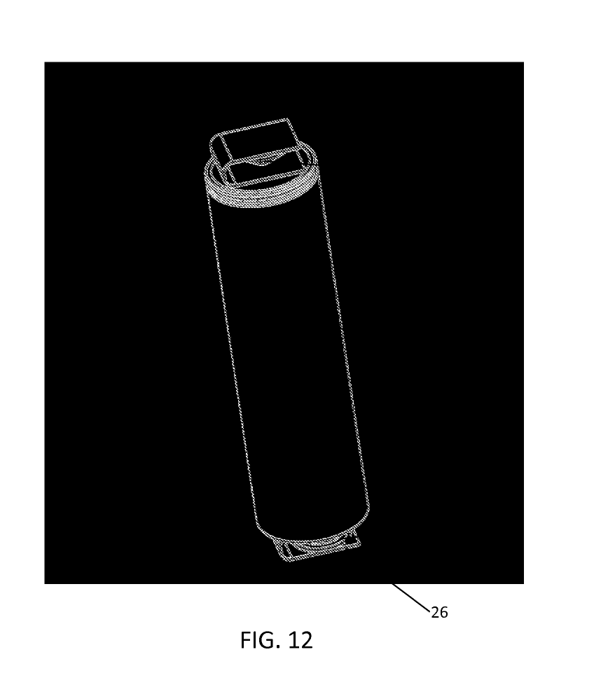

FIG. 12 shows another embodiment of an aspect of the invention. In the embodiment shown in FIG. 12, the electrically conductive element 26 is electrically coupled at the terminal of a cell 20. However, in this embodiment the electrically conductive element does not extend to contact cells in different rows. Rather, the combination of the spring like elements 16 and electrically conductive element 26 provide a means for the electrical and thermal coupling of a cell within a housing of fixed dimensions such as found between 2 parallel non-conductive boards 4.

Thus, specific apparatuses and methods relating to battery pack design have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. We claim a battery packaging apparatus with integrated spring contacts comprising:
an electrically conductive element wherein the electrically conductive element has a first and second surface and the first surface of the electrically conductive element is electrically coupled to a first battery at a first terminal on the first battery; and
a first spring like element wherein the first spring like element is coupled at a first area to the second surface of the electrically conductive element; and
wherein the electrically conductive element has a cross section such that the second surface contacts the first spring like element at a second area, whereby the first spring like element is operable for providing a force on the electrically conductive element when the first area is translocated toward the second area.

2. The apparatus of claim 1 wherein the first surface of the electrically conductive element is electrically coupled to a second battery at a second terminal on the second battery; and
wherein the second battery is adjacent to the first battery.

3. The apparatus of claim 2 further comprising
a second spring like element wherein the second spring like element is coupled at a third area to the second surface of the electrically conductive element; and
wherein the electrically conductive element has a cross section such that the second surface contacts the second spring like element at a fourth area, whereby the second spring like element is operable for providing a force on the second terminal of the second battery when the third area is translocated toward the fourth area.

4. The apparatus of claim 2 further comprising
a first band located circumferentially about the first battery; and
a second band located circumferentially about the second battery; and
wherein the first band and second band are operable for maintaining a discrete space between the first and second batteries when the first and second batteries are close packed.

5. The apparatus of claim 3 wherein the second spring like element and the first spring like element are constructed from a single element.

6. The apparatus of claim 2 further comprising
one or more batteries located in a row extending from the first battery wherein each of the one or more batteries are electrically coupled to the first surface of the electrically conductive element; and
one or more batteries located in a row extending from the second battery wherein each of the one or more batteries are electrically coupled to the first surface of the electrically conductive element.

7. The apparatus of claim 1 further comprising an electrically conductive strip that is mechanically secured to the first battery at a second terminal on the first battery.

8. An attachment apparatus for a battery management system comprising
a first planar conduction medium that is electrically coupled to one or more batteries that are at the same potential; and
a first electrically conductive trace with a first leg and a second leg that are substantially perpendicular wherein the first leg is electrically coupled to the first planar conduction medium; and
a connector for coupling the second leg of the first electrical trace to a battery management system.

9. The attachment apparatus of claim 8 wherein
the electric coupling between the first planar conduction medium and the first leg of the electrically conductive trace is maintained by a pressure applied on the first leg by a substantially parallel non-conductive surface.

10. The apparatus of claim 8 further comprising
a temperature sensor located on the first planar conduction medium.

11. The apparatus of claim 9 wherein the electrically conductive trace is located on a flexible PCB.

12. The apparatus of claim 9 further comprising
a second planar conduction medium that is electrically coupled to the opposite terminal of each of the one or more batteries which are coupled to the first planer conduction medium; and
a second electrically conductive trace with a first leg and a second leg that are substantially perpendicular wherein the first leg is electrically coupled to the second planar conduction medium; and
a connector for coupling the second leg of the second electrical trace to the battery management system.

13. An attachment apparatus for a battery management system comprising
a planar conduction medium that is electrically coupled to one or more batteries that are at the same potential; and
an electrically conductive trace that extends from the planar conduction medium wherein the electrically conductive trace is electrically coupled to the planar conduction medium and the electric coupling between the planar conduction medium and the electrically conductive trace is maintained by a pressure applied on the first leg by a substantially parallel non-conductive surface; and
a connector for coupling the electrical trace to a battery management system.
